(19) United States
(12) Patent Application Publication
(10) Pub. No.: US 2009/0277235 A1
(43) Pub. Date: Nov. 12, 2009

(54) Lock cylinder assembly

(76) Inventors: Chao-Ming Huang, Gangshan Town (TW); Chi-Ming Chen, Alian Shiang (TW)

Correspondence Address: Muncy, Geissler, Olds & Lowe, PLLC, P.O. BOX 1364, FAIRFAX, VA, 22038-1364, US

(21) Appl. No.: 12/149,688

(22) Filed: May 6, 2008

(51) Int. Cl. E05B 27/00

(52) U.S. Cl. 70/366

(57) ABSTRACT

A lock cylinder assembly comprises at least a cylinder body, a plug, a position block and a resilient member. The cylinder body has a hollow cylinder portion and the hollow cylinder portion has an inside wall and an axial groove recessed from the inside wall. The plug disposed within the hollow cylinder portion of the cylinder body has a front portion, a middle portion, a drive portion and a keyhole formed at the front portion and the middle portion. The position block is disposed at the keyhole of the plug adjacent to the drive portion and has a protrusion protruding from the plug. The protrusion is movably disposed within the axial groove of the hollow cylinder portion. The resilient member is disposed between the drive portion of the plug and the position block and one end of the resilient member contacts against the position block.

### FIELD OF THE INVENTION

The present invention is generally relating to a lock cylinder, more particularly to a lock cylinder assembly that utilizes position block for obtaining anti-prying and anti-hitting efficiency.

### BACKGROUND OF THE INVENTION

The known lock cylinder mainly comprises a cylinder body, a plug and a pin set, the cylinder body and the plug almost dispose pins, wherein the cylinder body disposes a plurality of upper pins having a same height and the plug disposes a plurality of lower pins having different heights. Because of the arrangement between the upper pins and the lower pins, the plug is position-limited by the upper pins or the lower pins unable to turn in the cylinder body, which may function as position-limitation and anti-turn. However, when burglar attempts to illegally unlock lock cylinder of known lock device, he might insert an unmatched key into a keyhole of the plug and provides an opportune beat on the lock, in which the lower pins in the plug are hit by the bitting of the unmatched key to simultaneously hit the upper pins between the cylinder body and the plug, that makes the upper pins move to the cylinder body, and then the plug is opportunely turned by the unmatched key to unlock easily, so that the known lock cylinder lacks in burglar-proofness and security seriously in a locked condition.

### SUMMARY OF THE INVENTION

The primary object of the present invention is to provide a lock cylinder assembly comprising at least a cylinder body, a plug, a position block and a resilient member. The cylinder body has a hollow cylinder portion which has an inside wall and an axial groove recessed from the inside wall. The plug disposed within the hollow cylinder portion of the cylinder body has a front portion, a middle portion, a drive portion and a keyhole formed at the front portion and the middle portion. The position block that is disposed at the keyhole of the plug adjacent to the drive portion has a protrusion protruding from the plug and is movably disposed at the axial groove of the hollow cylinder portion. The resilient member is disposed between the drive portion of the plug and the position block and one end of the resilient member contacts against the position block. If an unmatched key is inserted into the keyhole of the plug with opportune beat and turn to unlock in a locked condition, the unmatched key beats and moves the position block to the drive portion and the protrusion of the position block moves within the axial groove, which is unable to turn the plug. Accordingly, because the unmatched key cannot dissolve the limiting condition of the protrusion and the axial groove, a burglary attempting to turn the plug violently for unlocking with an unmatched key may be effectively prevented. In addition, the present invention also utilizes the position block and the resilient member to strength lock cylinder structure and increase unlocking difficulty for an unmatched key and thereby widely enhancing burglar-proofness and security of the lock cylinder assembly.

### DESCRIPTION OF THE DRAWINGS

FIG. 1 is a perspective exploded view of a lock cylinder assembly in accordance with the first preferred embodiment of the present invention.

FIG. 2 is a perspective assembly view of the lock cylinder assembly in accordance with the first preferred embodiment of the present invention.

FIG. 3 is an assembly sectional view of the lock cylinder assembly in accordance with the first preferred embodiment of the present invention.

FIG. 4A-FIG. 4C is a motion view showing a matched key is inserted into the lock cylinder assembly in accordance with the first preferred embodiment of the present invention.

FIG. 5 is a sectional view showing an unmatched key is inserted into the lock cylinder assembly.

FIG. 6A-FIG. 6B is a motion view showing an unmatched key is inserted into the lock cylinder assembly.

FIG. 7 is an assembly sectional view of a lock cylinder assembly in accordance with the second preferred embodiment of the present invention.

FIG. 8A-FIG. 8C is a motion view showing a matched key is inserted into the lock cylinder assembly in accordance with the second preferred embodiment of the present invention.

FIG. 9 is a sectional view showing an unmatched key is inserted into the lock cylinder assembly.

FIG. 10 is a motion view showing an unmatched key is inserted into the lock cylinder assembly.

### DETAILED DESCRIPTION OF THE INVENTION

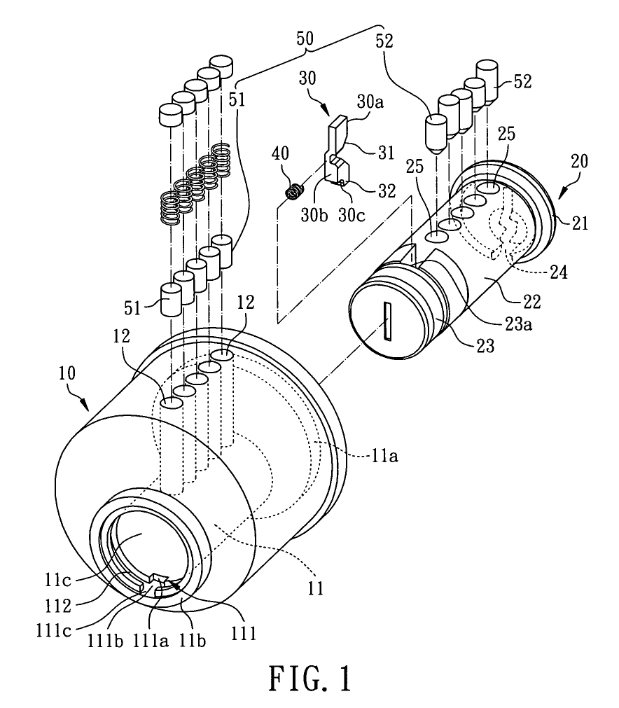

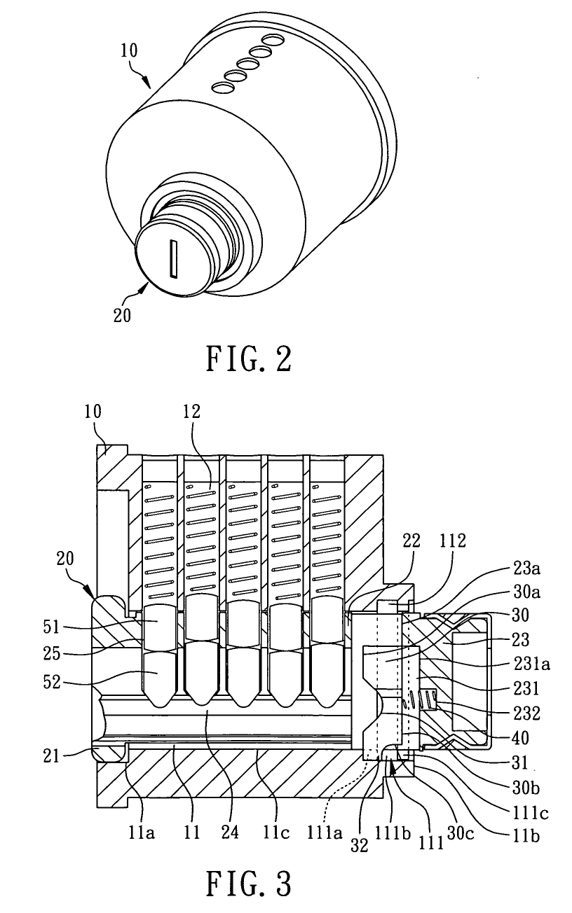

Referring to FIG. 1, 2 and 3, a lock cylinder assembly in accordance with the first preferred embodiment of the present invention comprises a cylinder body 10, a plug 20, a position block 30, a resilient member 40 and a pin set 50. The cylinder body 10 is a hollow cylinder in various appearances having a hollow cylinder portion 11 and a plurality of upper pin holes 12 in communication with the hollow cylinder portion 11. The hollow cylinder portion 11 has a first end 11a, a second end 11b opposite to the first end 11a, an inside wall 11c, an axial groove 111 located at the second end 11b and a radial groove 112 in communication with the axial groove 111, wherein the axial groove 111 and the radial groove 112 recess from the inside wall 11c. In this embodiment, the axial groove 111 comprises a first limiting area 111a, an overlapping area 111b and a second limiting area 111c, wherein the axial groove 111 communicates with and intersects the radial groove 112 at the overlapping area 111b, the first limiting area 111a and the second limiting area 111c are respectively located at two sides of the overlapping area 111b. The plug 20 disposed within the hollow cylinder portion 11 of the cylinder body 10 has a front portion 21 corresponding to the first end 11a of the hollow cylinder portion 11, a middle portion 22, a drive portion 23, a keyhole 24 formed at the front portion 21 and the middle portion 22 and a plurality of lower pin holes 25 formed at the middle portion 22. Referring again to FIG. 3, in this embodiment, the drive portion 23 has an inner end face 23a and an accommodating cavity 231 recessed from the inner end face 23a, and the accommodating cavity 231 has a bottom surface 231a. The keyhole 24 communicates with the lower pin holes 25. The lower pin holes 25 correspond to the upper pin holes 12 of the cylinder body 10 respectively before turning the plug 20. Referring again to FIGS. 1 and 3, the position block 30 which is disposed at the keyhole 24 of the plug 20 adjacent to the drive portion 23 protrudes from the plug 20 and corresponds to the axial groove 111 of the hollow cylinder portion 11 capable of limiting the plug 20 not to be turned around. In this embodiment, the position block 30 is capable of moving within the axial groove 111 and has a first end face 30a facing the keyhole 24, a notch 31 which recesses from the first end face 30a and corresponds to the keyhole 24, a second end face 30b opposite to the first end face 30a, a third end face 30c facing the axial groove 111 and a protrusion 32 protruding from the third end face 30c. The protrusion 32 protruding from the plug 20 is movably disposed within the axial groove 111 of the hollow cylinder portion 11 capable of limiting the plug 20 not to be turned around. Referring again to FIGS. 1 and 3, in this embodiment, the resilient member 40 is disposed between the drive portion 23 of the plug 20 and the position block 30 and one end of the resilient member 40 contacts against the second end face 30b of the position block 30. It is preferable that the drive portion 23 of the plug 20 has a cavity 232 recessed from the bottom surface 231a to dispose another end of the resilient member 40. The pin set 50 comprises a plurality of upper pins 51 and a plurality of lower pins 52 and which are disposed at the upper pin holes 12 and the lower pin holes 25 of the cylinder body 10 respectively capable of limiting the plug 20 not to be turned around.

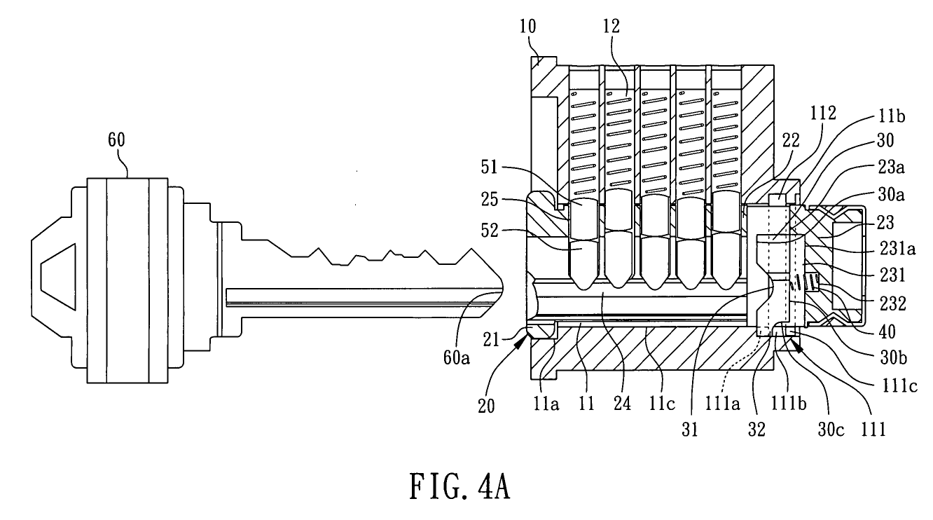

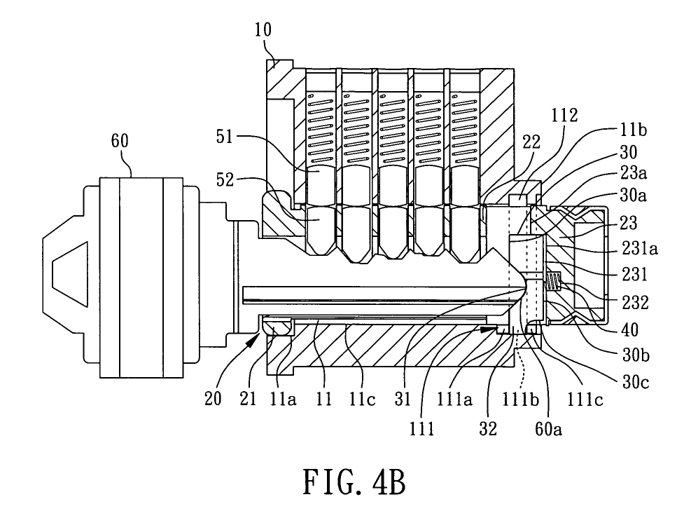

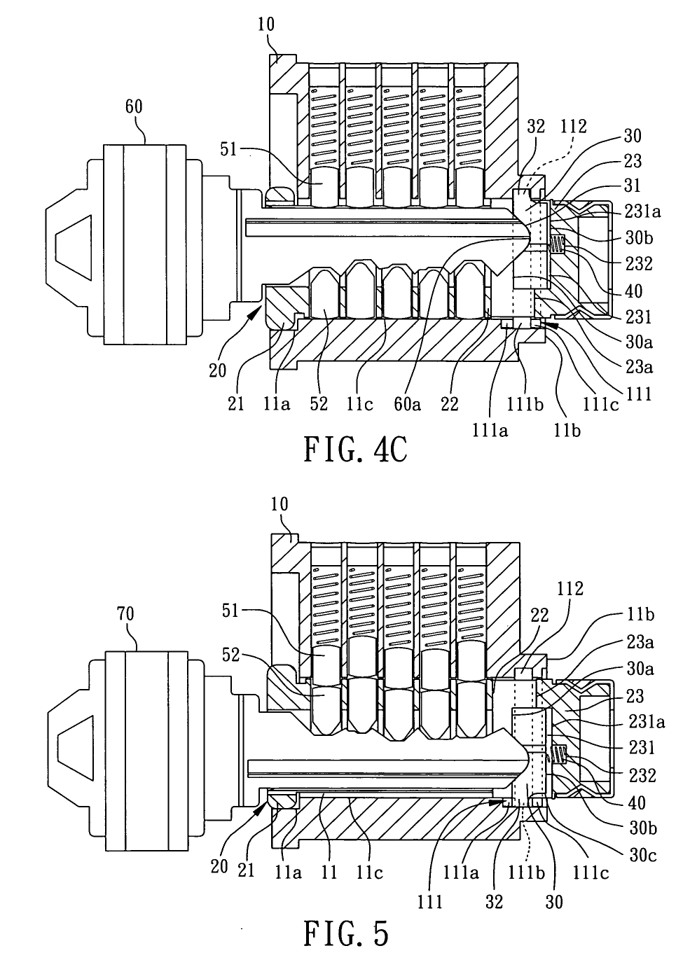

FIG. 4A-FIG. 4C illustrates motion of the lock cylinder assembly of this embodiment and first referring to FIG. 4A, which illustrates location of each component of the lock cylinder assembly before inserting a key. The protrusion 32 of the position block 30 is located at the first limiting area 111a of the axial groove 111 as to limit the plug 20 not to be turned around. Referring to FIG. 4B, when a matched key 60 is inserted into the keyhole 24 of the plug 20, an end 60a of the matched key 60 joins with the notch 31 of the position block 30 and the matched key 60 pushes and moves the position block 30 to the accommodating cavity 231. In this embodiment, the matched key 60 pushes the position block 30 allowing the protrusion 32 of the position block 30 to move to the overlapping area 111b, which may relieve limiting condition of the protrusion 32 and the axial groove 111. Next referring to FIG. 4C, when the matched key 60 turns the plug 20, the protrusion 32 of the position block 30 will move within the radial groove 112 of the hollow cylinder portion 11 to finish unlocking process. Besides, the resilient member 40 will pushes the position block 30 for restoration after the matched key 60 is pulled out from the plug 20 and the protrusion 32 restores to the first limiting area 111a of the axial groove 111 as to limit the plug 20 not to be turned around.

Referring to FIG. 5, if an unmatched key 70 is inserted into the keyhole 24 of the plug 20, although the unmatched key 70 may push the position block 30, it is unable to make the protrusion 32 of the position block 30 completely move to the overlapping area 111a, so the protrusion 32 is still limited at the first limiting area 111a of the axial groove 111 unable to relieve the condition of that the protrusion 32 limits the plug 20 not to be turned around. Therefore, a burglary attempting to turn the plug 20 violently for unlocking with the unmatched key 70 may be effectively prevented.

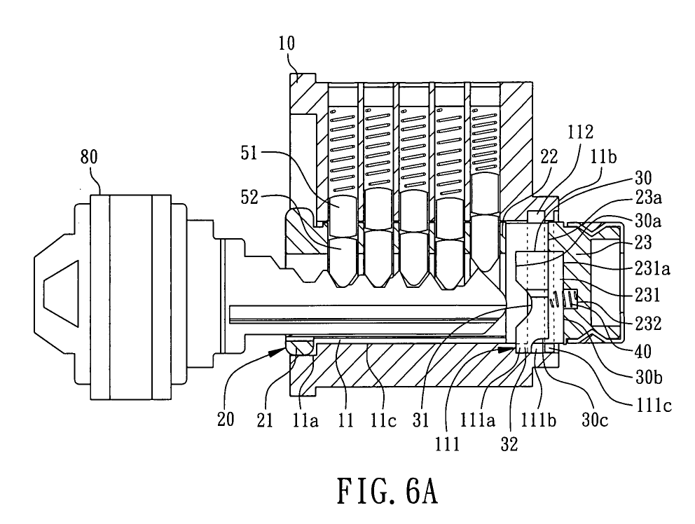

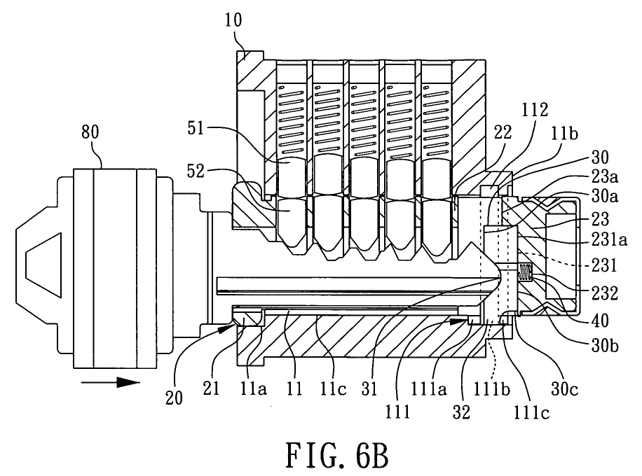

Referring to FIG. 6A-FIG. 6B, if an unmatched key 80 is inserted into the keyhole 24 of the plug 20 with opportune beat and turn for unlocking in a locked condition, first referring to FIG. 6A, when the unmatched key 80 doesn't hit the lower pins 52 and the position block 30, the protrusion 32 of the position block 30 is located at the first limiting area 111a of the axial groove 111 to limit the plug 20 not to be turned around. Next referring to FIG. 6B, the unmatched key 80 hits the lower pins 52 and the position block 30 momentarily to make the protrusion 32 of the position block 30 move from the first limiting area 111a of the axial groove 111 to the second limiting area 111c. At this moment, despite the upper pins 51 or the lower pins 52 cannot limit the plug 20 not to be turned around, but the protrusion 32 still can limit the plug 20 effectively. The present invention also utilizes the position block 30 and the resilient member 40 to strength lock cylinder structure and increase unlocking difficulty for an unmatched key and thereby widely enhancing burglar-proofness and security of the lock cylinder assembly.

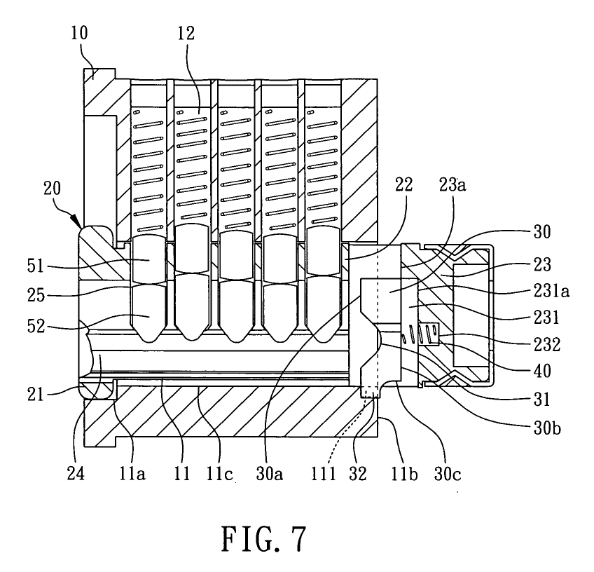

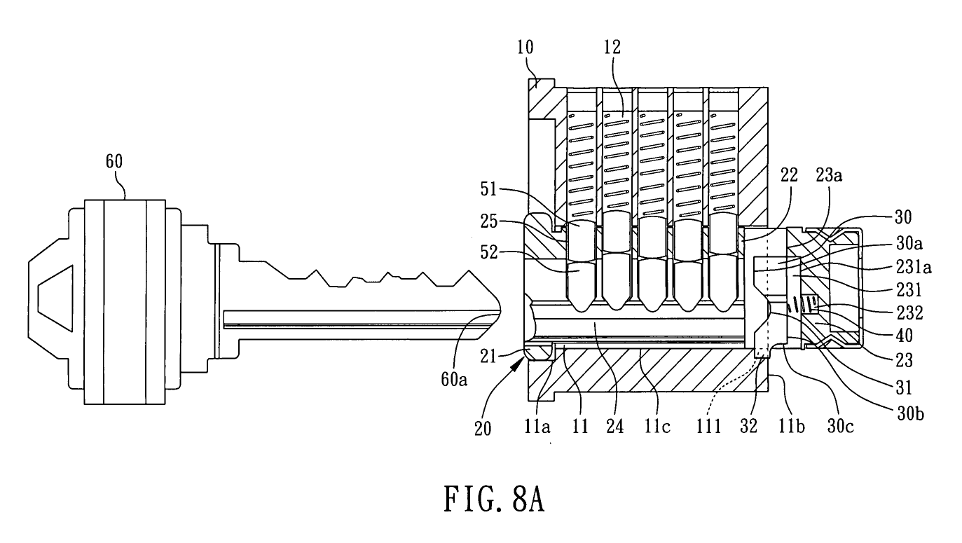

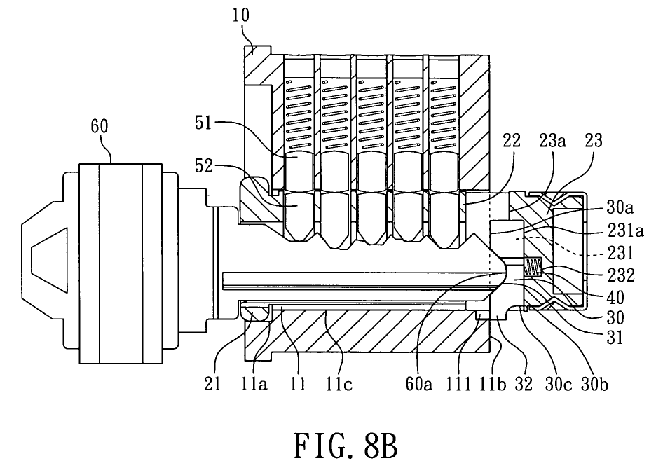

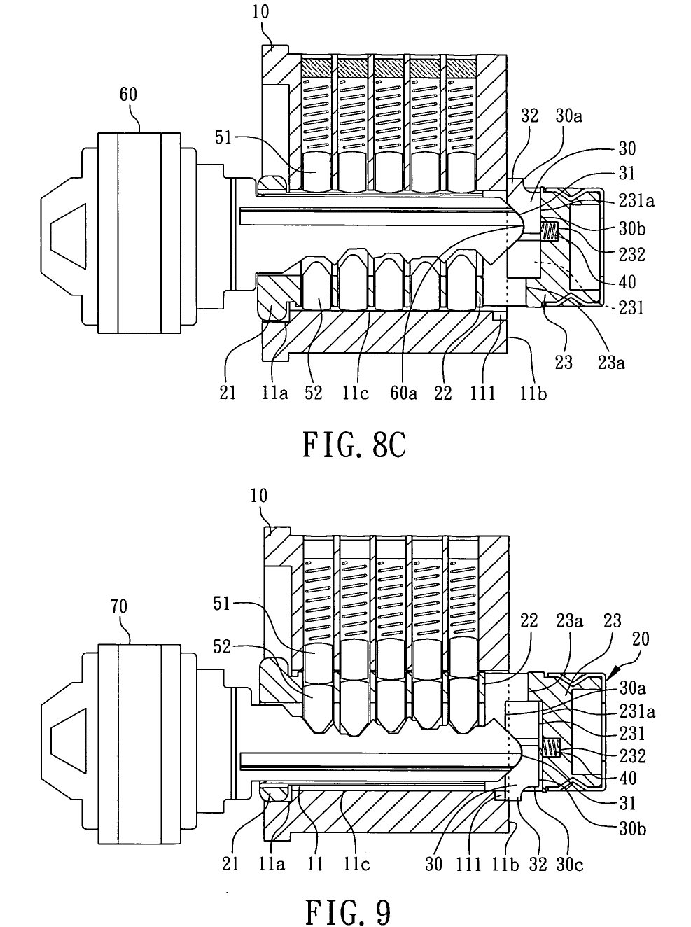

Referring to FIG. 7, which illustrates the second preferred embodiment of the present invention, the structural characteristic in this embodiment is basically the same as that in the first preferred embodiment, but the only difference is the radial groove 112 located at the hollow cylinder portion 11 of the cylinder body 10 which is omitted to fabricate in this embodiment. FIG. 8A-FIG. 8C illustrates motion of this embodiment and first referring to FIG. 8A, which illustrates location of each component of the lock cylinder assembly before inserting a key. The protrusion 32 of the position block 30 is located at the axial groove 111 of the hollow cylinder portion 11 to limit the plug 20 not to be turned around. Referring to FIG. 8B, when the matched key 60 is inserted into the keyhole 24 of the plug 20, the end 60a of the matched key 60 joins with the notch 31 of the position block 30 and the matched key 60 pushes and moves the position block 30 to the accommodating cavity 231. In this embodiment, the matched key 60 pushes the protrusion 32 of the position block 30 away from the axial groove 111 capable of relieving the condition of that the protrusion 32 limits the plug 20 not to be turned around and the protrusion 32 will be located at the exterior of the hollow cylinder portion 11 at this moment. Next referring to FIG. 8C, the matched key 60 turned the plug 20 for finishing unlocking process. The resilient member 40 pushes the position block 30 after pulling out the matched key 60 making the position block 30 restore and the protrusion 32 restores to the axial groove 111 remaining to limit the plug 20 not to be turned around.

Referring to FIG. 9, which illustrates an unmatched key 70 is inserted into the keyhole 24 of the plug 20, although the unmatched key 70 may push the position block 30, it is unable to make the protrusion 32 of the position block 30 completely move away from the axial groove 111, so that the condition of that the protrusion 32 limits the plug 20 not to be turned around cannot be dissolved. Therefore, a burglary attempting to turn the plug 20 violently for unlocking with the unmatched key 70 may be effectively prevented.

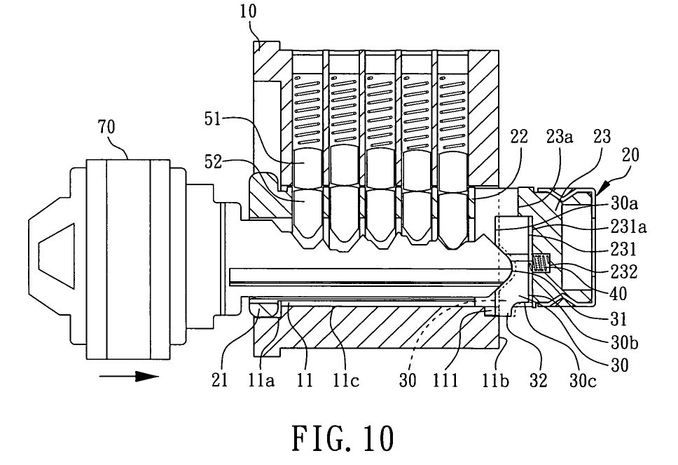

Referring to FIG. 10, if the unmatched key 70 is inserted into the keyhole 24 of the plug 20 with opportune beat and turn for unlocking in a locked condition, the position block 30 and the resilient member 40 will be hit by the unmatched key 70 to move momentarily and restore immediately, so the protrusion 32 is still located at the axial groove 111 to limit the plug 20 not to be turned round thereby widely enhancing burglar-proofness and security of the lock cylinder assembly.

While the present invention has been particularly illustrated and described in detail with respect to the preferred embodiments thereof, it will be clearly understood by those skilled in the art that various changed in form and details may be made without departing from the spirit and scope of the present invention.

What is claimed is:

1. A lock cylinder assembly comprising at least:
a cylinder body having a hollow cylinder portion, wherein the hollow cylinder portion has an inside wall and an axial groove recessed from the inside wall;
a plug disposed within the hollow cylinder portion and having a front portion, a middle portion, a drive portion and a keyhole formed at the front portion and the middle portion;
a position block disposed at the keyhole of the plug and having a protrusion protruding from the plug, wherein the protrusion is movably disposed within the axial groove of the hollow cylinder portion; and
a resilient member disposed between the drive portion of the plug and the position block.

2. The lock cylinder assembly in accordance with claim 1, wherein the hollow cylinder portion further has a radial groove in communication with the axial groove, the axial groove comprises a first limiting area and an overlapping area, the axial groove intersects the radial groove at the overlapping area.

3. The lock cylinder assembly in accordance with claim 2, wherein the axial groove further comprises a second limiting area, the first limiting area and the second limiting area are respectively located at two sides of the overlapping area.

4. The lock cylinder assembly in accordance with claim 2, wherein the protrusion of the position block is capable of moving within the radial groove.

5. The lock cylinder assembly in accordance with claim 1, wherein the position block has a first end face facing the keyhole, a second end face opposite to the first end face and a third end face facing the axial groove, the protrusion protrudes from the third end face.

6. The lock cylinder assembly in accordance with claim 5, wherein one end of the resilient member contacts against the second end face of the position block.

7. The lock cylinder assembly in accordance with claim 5, wherein the position block has a notch recessed from the first end face, the notch corresponds to the keyhole of the plug.

8. The lock cylinder assembly in accordance with claim 1, wherein one end of the resilient member contacts against the position block.

9. The lock cylinder assembly in accordance with claim 8, wherein the drive portion of the plug has a cavity, another end of the resilient member is disposed at the cavity of the drive portion.

10. The lock cylinder assembly in accordance with claim 1, wherein the drive portion of the plug has an inner end face and an accommodating cavity recessed from the inner end face, the position block corresponds to the accommodating cavity.

11. A lock cylinder assembly comprising at least:
a cylinder body having a hollow cylinder portion, wherein the hollow cylinder portion has an inside wall and an axial groove recessed from the inside wall;
a plug disposed within the hollow cylinder portion of the cylinder body and having a front portion, a middle portion, a drive portion and a keyhole formed at the front portion and the middle portion; and
a position block disposed at the keyhole of the plug, protruding from the plug and corresponding to the axial groove of the hollow cylinder portion.

12. The lock cylinder assembly in accordance with claim 11, further comprising a resilient member disposed between the drive portion of the plug and the position block, one end of the resilient member contacts against the position block.

13. The lock cylinder assembly in accordance with claim 11, wherein the hollow cylinder portion has a first end corresponding to the front portion of the plug and a second end opposite to the first end, the axial groove is located at the second end.

14. The lock cylinder assembly in accordance with claim 11, wherein the position block is capable of moving within the axial groove of the hollow cylinder portion.

15. The lock cylinder assembly in accordance with claim 11, wherein the hollow cylinder portion further has a radial groove in communication with the axial groove, the axial groove comprises an overlapping area.

16. The lock cylinder assembly in accordance with claim 15, wherein the position block is capable of moving within the radial groove.

17. The lock cylinder assembly in accordance with claim 11, wherein the position block has a first end face facing the keyhole, a second end face opposite to the first end face and a third end face facing the axial groove, one end of the resilient member contacts against the second end face of the position block.

18. The lock cylinder assembly in accordance with claim 17, wherein the position block has a notch recessed from the first end face, the notch corresponds to the keyhole of the plug.

19. The lock cylinder assembly in accordance with claim 12, wherein the drive portion of the plug has a cavity, another end of the resilient member is disposed at the cavity of the drive portion.

20. The lock cylinder assembly in accordance with claim 11, wherein the drive portion of the plug has an inner end face and an accommodating cavity recessed from the inner end face, the position block corresponds to the accommodating cavity.
